(19) United States
(12) Patent Application Publication
(10) Pub. No.: US 2004/0212117 A1
(43) Pub. Date: Oct. 28, 2004

(54) Clay bead roller system and method

(76) Inventor: Janet Sue Lee, Woodson, IL (US)

Correspondence Address: Donald W. Meeker, Patent Agent, 924 East Ocean Front #E, Newport Beach, CA, 92661, US

(21) Appl. No.: 10/850,728

(22) Filed: May 20, 2004

Related U.S. Application Data
(63) Continuation-in-part of application No. 10/269,132, filed on Oct. 12, 2001.

(51) Int. Cl. B29C 67/02

(52) U.S. Cl. 264/40.1; 425/332; 425/333; 264/117

(57) ABSTRACT

An elongated top and an elongated base each having mated roller components in the shape of mating inverted elongated surfaces which form a rolling bead roller chamber therebetween. The bead roller is injection molded of polycarbonate to be non-reactive with polymer clay, and it is transparent to enable the observation of the bead rolling process. Multiple roller components may be built into a base with mating multiple roller components built into a top with a handle or individual top roller components. A bead log roller with protruding measurement marks rolls clay logs with embossed measurement marks which may be cut to an appropriate size. An aligned series of notches transversely on parallel ridges of the bead roller tool allows a pin to skewer the beads through the exact axis of symmetry of the beads to form holes in the beads for stringing and to lift the beads to place them on a drying tray with similar notches along parallel ridges with troughs under the beads on the pin.

### REFERENCES TO RELATED APPLICATIONS

This is a continuation-in-part of utility patent application Ser. No. 10/269,132 filed Oct. 12, 2001.

### BACKGROUND OF THE INVENTION

1. Field of the Invention

The present invention relates to the art of forming shapes in plastic media and in particular to a bead roller and method for forming polymer clay beads and other plastic media beads of various uniform and consistent shapes.

2. Description of the Prior Art

A common sculpting medium is clay, which is of mineral origin and comes either in water-based or oil-based form. Water-based clays are typically used by the artist or craftsperson to fashion pottery or small figurines and require a high heat firing process which can damage the clay.

One class of sculpting medium is polymer based. One such formulation incorporates polyvinyl chloride as the filler. Formation of a permanent sculpture usually requires a curing process at a much lower elevated temperature than the water based clay. The polymer clay comes in a wide variety of greatly diverse bright colors which are usually combined in decorative patterns in the clay enabling the polymer clay to be formed into attractive colorful items, such as beads for jewelry or for use in accessory items such as purses. Some materials react chemically with polymer clay so that the clay marks the materials.

Forming polymer clay beads has become a very popular craft or art form. Typically such beads are formed by hand or sometimes by rolling with a makeshift device such as cut plastic (PVC) pipe found only in round shapes. There was always a lack of uniformity and lack of precision forming in the beads produced by hand forming. Some prior art attempts have been made in forming other plastic materials, such as dough, into shapes, but a system and method using mass producible materials for forming polymer beads in consistent and accurate shapes and sizes has been lacking.

U.S. Pat. No. 6,224,365, issued May 1, 2001 to Robert Ou-Young, provides an apparatus including two symmetrical slide members moved relative each other for shaping a cylindrical body into a plurality of spherical bodies, wherein the slide members each have two vertical sidewalls, and a plurality of U-grooves and partition flanges alternatively arranged in parallel between the vertical sidewalls, the U-grooves each having two distal ends and a depth gradually increased from one distal end to the other, the partition flanges each having two distal ends and a thickness gradually increased from one distal end to the other, the vertical sidewalls each having two distal ends and an inner side vertically curved inwards, the inner side having a vertical depth gradually increased from one distal end to the other.

U.S. Pat. No. 432,127, issued Jul. 15, 1890 to Samuel C. Dyke, shows an improvement to devices for performing one step in the process of manufacturing playing marbles from plastic clay by accurately rounding or rendering slugs of clay spherical.

U.S. Pat. No. 33,136, issued Aug. 27, 1861 to Adam Exton, describes a machine for molding dough into crackers, biscuits, etc., using fluted or grooved plates for molding the dough.

U.S. Pat. No. 2,231,556, issued Feb. 11, 1941 to Leonard G. Arpin, relates a method to manufacture spherical articles such as beads and marbles of all types, especially made from plastic material formed into rods, which is then maintained between grinding elements shaped in semi-circular grooves so that a ball is formed for each groove of the grinder element.

U.S. Pat. No. 2,241,365, issued May 6, 1941 to Maximilian C. Meyer, puts forth novel method of forming ornamental objects from plastics containing faceted light reflecting particles.

What is needed is mass produced equipment as part of a system and method for supplying all of the bead making enthusiasts with a consistent and uniform system and method for forming polymer beads quickly and easily in any quantity desired.

### SUMMARY OF THE INVENTION

An object of the present invention is to provide a system and method for rolling clay beads which provides uniformity and consistency of each shape and size of beads for a variety of different shapes and sizes of beads by using measured amounts of polymer clay or other similar material in rolling equipment having components configured in different sizes and shapes which consistently produce uniformly shaped beads.

Another primary object of the present invention is to provide a complete system of forming uniformly accurate beads from start to finish with a measurement embossing adjustable height log roller for rolling out logs of polymer clay of appropriate diameters for the intended bead roller with the measurements for cutting the exact length of clay needed for each bead roller chamber, paired roller components which each produce a variety of differently sized and or differently shaped beads uniformly shaped as desired with a transverse opening through the roller device to admit a pin therethrough to pierce the bead through the exact axis of the bead in the roller making the hole for stringing the bead and a recessed pin rolling ledge on each ridge of the roller device to allow the bead to be rolled on the pin to smooth out deformations made by the pin piercing the bead and further enable the bead (or beads in a series of parallel bead forming chambers) to be removed and positioned on a drying rack by holding the pin and not touching the bead for perfectly formed beads.

Another object of the present invention is to provide a system for rolling polymer or other clay type beads and with components which can be mass produced by injection molding techniques to supply a widespread demand.

One more object of the present invention is to provide bead rolling equipment which is formed of transparent material to enable the user to view the bead as it is being rolled to insure that the bead will be rolled exactly as desired and it will be apparent when the bead is fully rolled. While prior art devices create spherical bodies they are created in a single pass. The beads of the present invention are formed by rolling the polymer clay back and forth while watching the formation of the bead through the transparent walls of the bead roller so that the process is continued until the bead is formed in the desired shape.

An additional object of the present invention is to provide bead rolling equipment which is fabricated of a material, polycarbonate, which is impervious to chemical reaction with polymer clay to insure that the equipment will last indefinitely and can be used an unlimited number of times and maintain a smooth surface for proper rolling of the beads. This material is very durable and works well with any type of clay or other similar material, including Crayola Model Magic Modeling Compound, Creative Paper Clay, Aleene's Recipe Bread Dough, and La Doll Air Dry Clay.

A further object of the present invention is to provide bead rolling equipment which has a number of compartments for simultaneously rolling a number of beads possibly of different sizes or shapes at the same time or a series of differently sized top components which all work with the same bottom component to produce differently sized beads.

Yet one more object of the present invention is to provide aligned openings transversely through all the surfaces of the bead roller tool to form a series of “pin tracks” to receive a bead hole making pin therethrough so that the bead can be pierced while it is still in the bead roller tool. With the newly formed bead sitting in alignment with the “pin tracks” getting the hole right through the center is much easier than when trying to do piercing while holding the bead. The pin having it's “track” helps the pin be guided straight through the center of the bead(s).

A corollary object of the present invention is to provide a recessed edge between each of the pin tracks and the adjacent end of the bead rolling tool in which recess the pin can roll so that the bead can be re-shaped in case of any distortion caused by the piercing while the pin is through the center of the beads to produce a perfectly shaped bead with a very smooth surface and no fingerprints.

One more object of the present invention is to provide a heat resistant bead drying rack, preferably of aluminum with four elevated longitudinal edges forming three recessed troughs between ridges, each of the ridges having aligned pin notches running transversely across all of the ridges to receive pins sufficiently long to rest in the notches across the rack with formed beads skewered on the pins elevated above each of the troughs for drying the beads so that the beads can be removed from the rollers and dried until hard all without touching the beads thereby providing smooth beads with no finger indentations or fingerprints. Flat items can be placed on the bottom in the troughs under the beads. The rack is sufficiently small to fit into a toaster oven to cure the beads. There are preferably 9 aligned pin notches so the rack will hold 27 pins.

A related object of the present invention is to provide a polymer clay log roller which imparts measurement lines to the log so that the log may be cut into the desired sizes of clay to insert in the bead roller chambers.

Still another object of the present invention is to provide at least one and preferably two clay overflow channels in the bead roller tool outside and adjacent to the outermost bead rolling chamber on each side of the tool to receive excess clay so precision clay measuring is not essential.

A directly related object of the present invention is to provide sharp pointed mating edges between the pair of bead rolling tools between the outermost bead rolling chamber and the clay overflow channels to cut of the excess clay cleanly and allow it to fall into the overflow channels.

A contributory object of the present invention is to provide measuring means for cutting a precise amount of clay for precision in sizing the amount of clay inserted in the bead roller chamber to make each of the beads.

One further object of the present invention is to provide a bead roller tool in which the base piece and the top piece are exactly the same so that they may be made from the same mold to save cost of manufacturing and also to provide easier replacement of parts as well as insuring a precision made bead since the two sides of the bead rolling chamber are identical.

A related object of the present invention is to provide mating channels along the length of the two components with a guide bar inserted in one channel to ride in the other channel to insure even alignment of the two sides as they are moved back and forth to make a perfectly formed bead.

An associated object of the present invention is to provide the bead roller surface with a texture to impart a texture to the bead for additional visual interest.

In brief, the present invention provides a complete system of forming uniformly accurate beads from start to finish with a measurement embossing adjustable height log roller for rolling out logs of polymer clay of appropriate diameters for the intended bead roller with the measurements for cutting the exact length of clay needed for each bead roller chamber, paired roller components which each produce a variety of differently sized and or differently shaped beads uniformly shaped as desired with a transverse opening through the roller device to admit a pin therethrough to pierce the bead through the exact axis of the bead in the roller making the hole for stringing the bead and a recessed pin rolling ledge on each ridge of the roller device to allow the bead to be rolled on the pin to smooth out deformations made by the pin piercing the bead and further enable the bead (or beads in a series of parallel bead forming chambers) to be removed and positioned on a drying rack by holding the pin and not touching the bead for perfectly formed beads.

Alternately, the present invention provides a system for bead rolling with rulers and cutters for measuring and cutting a precise quantity of polymer or other type of clay or similar material to put into the rollers.

The bead rollers each have two mating elongated components of a similar cross-sectional shape with one or more bead rolling chambers, which components are moved back and forth along the length of the rollers with the measured amount of polymer clay between them to create a bead of an exact and uniform shape based on the cross-sectional shape.

The bead rollers preferably further comprise at least one and preferably two clay overflow channels in the bead roller tool outside and adjacent to the outermost bead rolling chamber on each side of the tool to receive excess clay so precision clay measuring is not essential.

A directly related object of the present invention is to provide sharp pointed mating edges between the pair of bead rolling tools between the outermost bead rolling chamber and the clay overflow channels to cut of the excess clay cleanly and allow it to fall into the overflow channels.

Half round roller components produce circular beads. V-shaped roller components produce double-cone shaped beads. Partial circular arc shaped roller components produce oval or football-shaped beads. Roller components having long central parallel flat surfaces with outwardly angled ends produce cylindrical beads with cone-shaped ends. Many other shapes could also be used within the scope of the invention.

Two roller components may be formed with one fitting into a track with side edges on the other to insure uniform sliding of one relative to the other. Various sizes of top roller components may be used inside a base roller component of equal or larger size and having the same cross-sectional shape.

A multi-unit base may have several differently sized roller components of the same cross-sectional shape or of different cross-sectional shapes. The base may be used with single top roller components of various sizes or a multi-unit top with roller components the same sizes as the base, both the single and multi-unit top having matching cross-sectional shapes to the base components.

In one embodiment of the bead roller tool, the base piece and the top piece are exactly the same so that they may be made from the same mold to save cost of manufacturing and also to provide easier replacement of parts as well as insuring a precision made bead since the two sides of the bead rolling chamber are identical. Mating channels along the length of the two components have a guide bar inserted in one channel to ride in the other channel to insure even alignment of the two sides as they are moved back and forth to make a perfectly formed bead.

A bead roller surface may be provided with a texture on the roller surface to impart a texture to the bead for additional visual interest.

Preferably the rollers are injection molded of polycarbonate material which is resistant to chemical reaction with the polymer clay and very durable to endure prolonged and repeated use. The bead rollers are transparent so that the rolling of the clay to form a bead can be observed to insure quality and to see when the bead is fully rolled.

An advantage of the present invention is to provide mass produced bead roller systems to meet a growing demand.

Another advantage of the present invention is to provide uniformity and consistency of shape and size of clay beads.

An additional advantage of the present invention is to provide bead rollers which produce multiple clay beads at the same time.

One more advantage of the present invention is to provide a bead roller which enables the user to watch the bead being rolled.

Yet another advantage of the present invention is to provide bead rollers that will produce beads in a variety of sizes and shapes.

A still further advantage of the present invention is that it enables, in both bicone and oval bead shapes, to have a pattern “swirled” around the bead by rolling a bead (other than solid color) in one direction repeatedly in the bead roller.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of a multi-roller-component base and multi-roller-component top having mating half circle cross-section roller components of different sizes with a single handle on the top and tracks along the side edges of the base for sliding the sides of the in the tracks;

FIG. 2 is an end elevational view of a multi-roller-component base having half circular cross-section roller components of different sizes with each roller component having side tracks and a single mating circular cross-section individual top roller component sliding in each of the tracks as well as other single partial circular arc shaped top roller components used with each base roller component having a similar arc radius and also showing the beads produced by each combination;

FIG. 3 is a transverse cross-sectional view taken through a bead roller of the present invention having a single V-shaped roller component in the base with side tracks running longitudinally and a mating single inverted V-shaped roller component with a handle in the top riding in the tracks and showing the edge of alternate single top inverted V-shaped roller components of various sizes, such as those of FIGS. 4A and 4B, riding in the base V-shaped roller component, all having the same V angle, and further showing the double conical pointed end beads produced by each of the roller component top and bottom V-shaped pairs;

FIG. 4A is an end elevational view of a multiple sized V-shaped roller component in two elongated pieces having mating elongated angled surfaces of different widths which form two different sized V-shaped roller components, one on top and a different one on the bottom when connected together as in FIG. 4A with the piece having protruding pegs on the right and the piece having receiving openings on the left;

FIG. 4B is an end elevational view of the multiple sized V-shaped roller component of FIG. 4A having two different sized V-shaped roller components dissimilar to those of FIG. 4A due to having the piece having protruding pegs on the left and the piece having receiving openings on the right to match differently sized angled surfaces;

FIG. 5 is an end elevational view taken through a bead roller of the present invention having a single partial circle arc-shaped roller component in the base and a mating single partial circle arc-shaped roller component with a handle on the top riding in the lower bead roller component and showing the oval football-shaped beads produced by the mating roller components;

FIG. 6 is a perspective view showing a bead roller of the present invention with two mating roller components having in cross-section long central parallel flat surfaces with outwardly angled ends and showing a cylindrical bead with cone-shaped ends produced by the mating roller components;

FIG. 7 is a perspective view showing the bead roller of the present invention having a base with a V-shaped roller component and a semicircular shaped roller component on one surface and a partial circle arc roller component on an opposite side with mating single top roller components aligned with the base components for rolling;

FIG. 8 is an end elevational view of a pair of identical bead roller components facing each other to form a bead roller tool with mating guide channels and a guide bar to guide the movement of the components, and also excess clay overflow channels with sharp clay cutting ridges between the bead roller channels and the clay overflow channels;

FIG. 9 is an end elevational view of one of an alternate pair of identical bead roller components having differently shaped bead roller channels from that of FIG. 8;

FIG. 10 is a side elevational view of one of the bead roller components of FIG. 8 showing the pin notch and pin rolling guide ridge on each end;

FIG. 11 is a diagrammatic view showing various cross-sectional shapes of bead roller chambers and the bead shapes produced therein;

FIG. 12 is a perspective view of one of the bead roller components of FIG. 8;

FIG. 13 is a perspective view of a bead drying rack with rolled beads skewered by pins resting in bead drying pin notches in parallel ridges with troughs in-between adjacent ridges to leave the beads elevated out of contact with the rack;

FIG. 14 is a perspective view of the clay log roller showing two different paired side size options for varying the diameter of the clay logs and showing the elevated measurement markings on the clay rolling cross piece;

FIG. 15 is a perspective view of two clay logs of different diameters based on the height of the paired sides in the clay log roller of FIG. 14 and showing the embossed measurement marks on the logs for cutting the logs into desired lengths for placement in different bead roller chambers;

FIG. 16 is a side elevational view of the clay log roller of FIG. 14 rolling a log of clay on a horizontal surface.

### BEST MODE FOR CARRYING OUT THE INVENTION

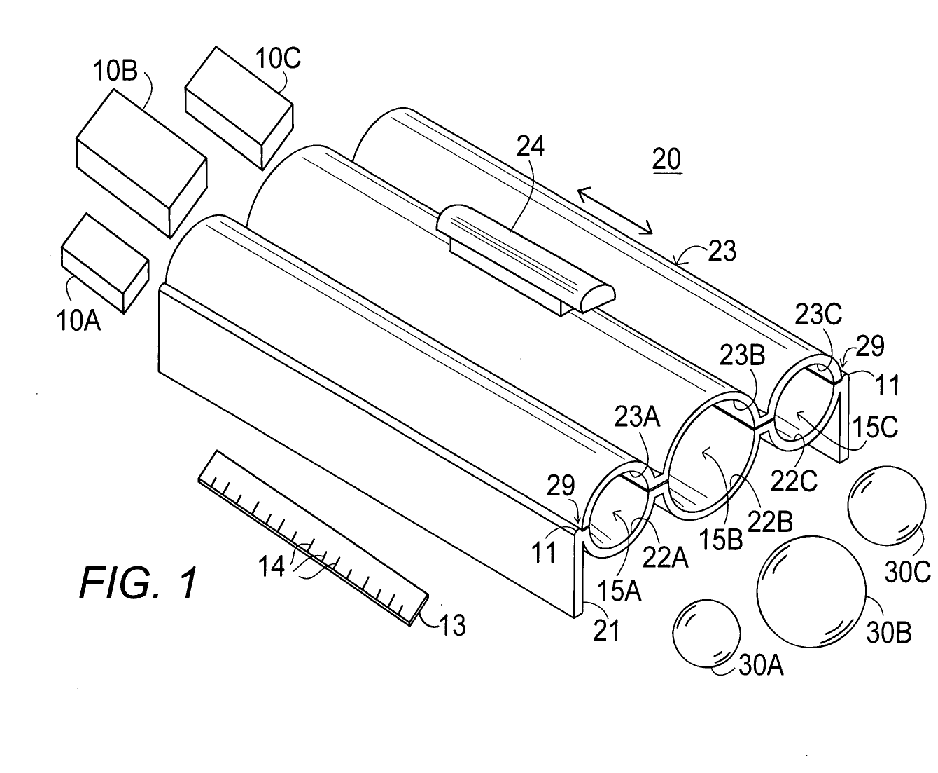

In FIGS. 1-3 and 5-7, a bead roller device 20A-E for rolling uniformly shaped and sized beads of clay polymer and other similar material comprises an elongated tool having at least one pair of roller components having elongated matched surfaces, such as matched top roller components 23A-C and bottom roller components 22A-C respectively of FIG. 1 capable of coming into mutual contact to form a bead roller chamber, such as a cylindrical bead roller chamber 15A-C, between the matched surfaces. The bead roller chamber is capable of receiving a measured amount of polymer or other type of clay 10A-C or similar material therein, and the pair of roller components capable of relative back and forth motion in the direction of elongation, as shown by the double ended arrow of FIG. 1, to roll the clay between the elongated matched surfaces to form a bead, such as a spherical bead 30A-C of FIG. 1, having a smooth shape with a circular transverse cross-section and a shape and size uniformly matched to other beads rolled therein.

The measured amount of clay 10A-C can be measured with a measuring tool, such as a ruler 13 with marked length measurements 14 and the clay, of uniform cross-section as packaged, cut into appropriately sized amounts for each bead roller chamber 15A-C.

The bead roller devices are formed by a mass production process, such as injection molding of a material, such as polycarbonate, resistant to chemical interaction with polymer clay. The bead roller devices are formed of transparent material so the bead may be observed during the rolling process to insure quality and know when the rolling is completed.

The bead roller device comprises a base 21 and 21A-E having a bottom surface capable of resting in a stationary position on an external surface and a top 23 and 28A-J having a means for gripping, such as a handle 24, 24A and 24B so that the top is capable of being gripped by hand and moved back and forth relative to the base in the direction of elongation.

In FIGS. 1, 2, and 7 the base 21, 21A, and 21E comprises three roller components secured thereto. In FIG. 1, the bottom roller components 22A, 22B, and 22C are variously sized elongated surfaces of semicircular cross-section. The top 23 has three top roller components 23A-C built in of variously sized elongated surfaces of semicircular cross-section to mate with the bottom roller components 22A-C and form a cylindrical roller chamber 15A-C. The handle 24 is gripped for moving the top 23 relative to the base 21 back and forth in the direction of elongation, as shown by the double arrow, with the side edges of the top sliding in tracks 29 formed by elevated ridges 11 along the top side edges of the base 21, to roll the measured amounts of clay 10A-C into uniformly shaped spherical beads 30A-C of three different sizes.

In FIG. 2, a base 21A has three differently sized semicircular bottom roller components 22A, 22B, and 22C with top tracks 29 between each defined by protruding ridges 11 above adjacent flat surfaces. In this embodiment, three separate semicircular top roller components 28A, 28B, and 28C riding in the three tracks, each with its own handle 24A to move back and forth relative to the mating bottom roller components 22A-C The semicircular mating roller elements form cylindrical bead roller chambers 15A-C to produce spherical beads 30A-C of different sizes.

Also shown in FIG. 2 are three alternate separate top roller components 28D, 28E, and 28F each having an arc of a circle with a mating diameter to the bottom semicircular roller components, so that each of the top roller components 28D-F may be placed within each of the mating diameter bottom roller components 22A-C to create elongated oval bead roller chambers 16A, 16B, and 16C to produce oval football-shaped beads 31D, 31E, and 31F.

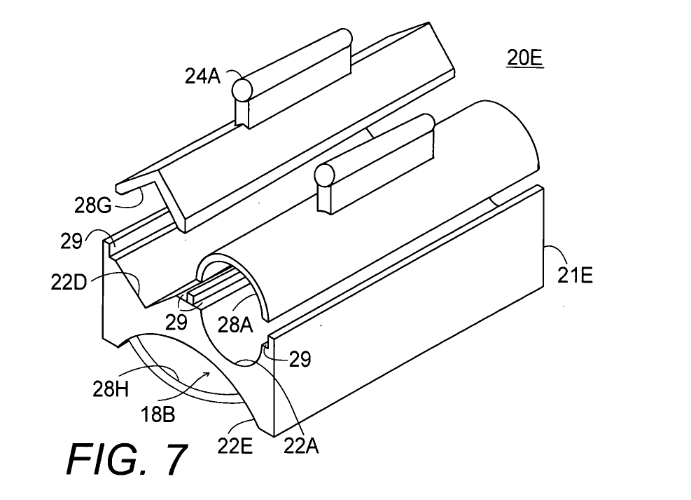

In FIG. 7, a base 21E has multiple roller components of different shapes, including an elongated surface V-shaped in cross-section forming a V-shaped roller component 22D with a mating single inverted V-shaped top roller component 28G, an elongated surface semicircular in cross-section forming a semicircular roller component 22A with a mating top semicircular roller component 28A, both on one side and, on the opposite side, an elongated surface having an arc of a circle in cross-section forming an arc-shaped roller component 22E with a mating arc shaped single roller component 28H.

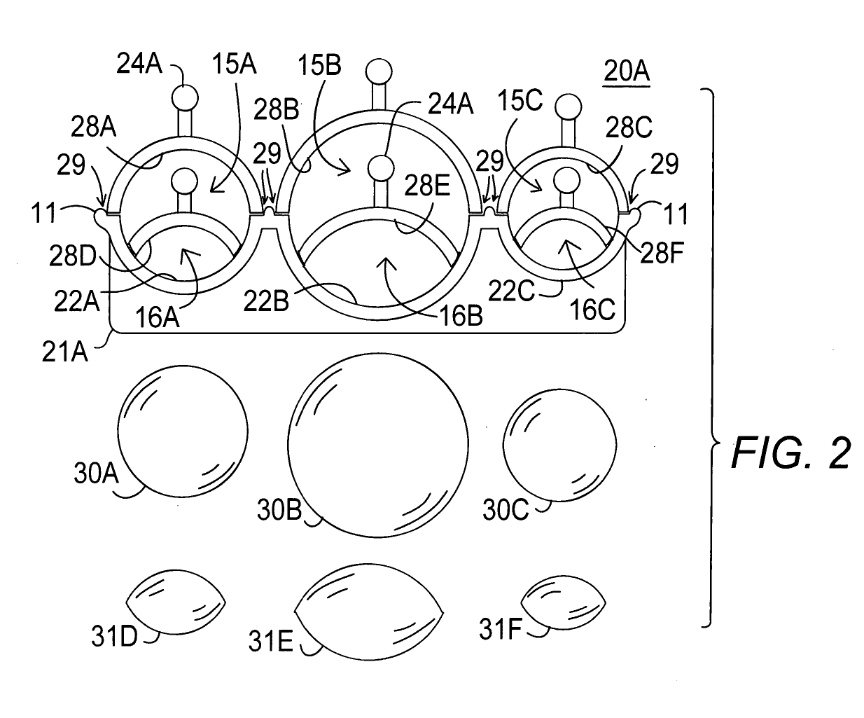

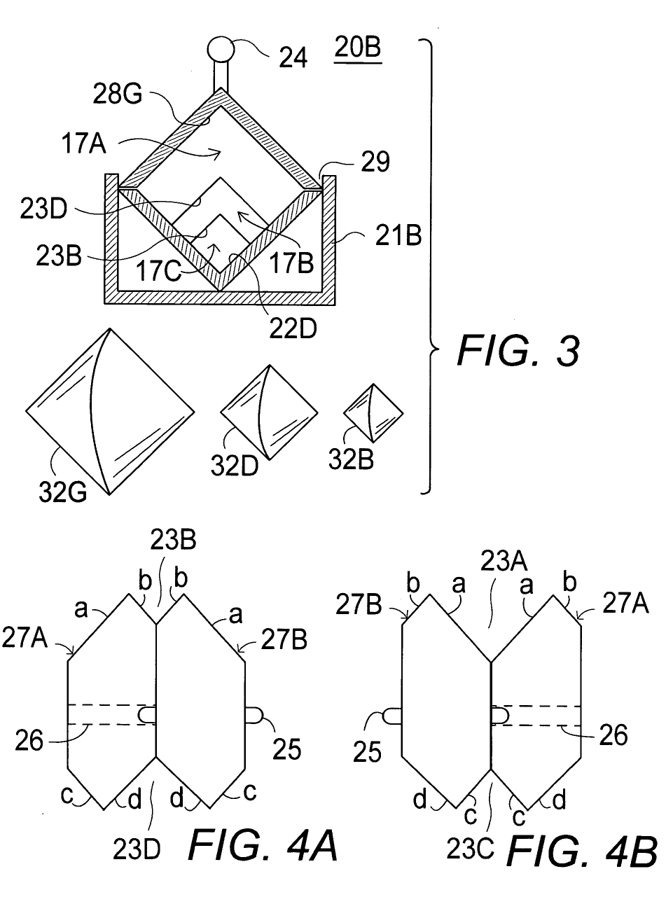

In FIGS. 3-6 each base 21B, 21C, and 21D has a single bottom roller component which can be used with single top roller components. In FIG. 3 the base 21B has a built-in elongated surface V-shaped in cross-section forming a V-shaped roller component 22D with a mating single inverted V-shaped top roller component 28G sliding in side tracks 29 to form double conical shaped beads 32G.

In FIGS. 4A and 4B, an elongated element having two pieces, a first multisided piece 27A and a second multisided piece 27B of mirror image in cross-section interlocked by protruding knobs 25 from the second piece 27B engaging an opening 26 through the first piece 27A to enable attachment on one side with the first piece 27A on the left, as in FIG. 4A, or attachment on the other side with the first piece 27A on the right, is in FIG. 4B. Each piece has elongated angled surfaces of four different widths with two surfaces a and b on the top and two surfaces c and d on the bottom. In FIG. 4A, when connected together the two pieces, 27A on the left and 27B on the right, form a multiple sized V-shaped roller component, which form two different sized V-shaped roller components 23B and 23D, one 23B with sides b-b on top and a different one 23D with sides d-d on the bottom. In FIG. 4B, when connected together the two pieces, with 27B on the left and 27A on the right, form a multiple sized V-shaped roller component, which form two different sized V-shaped roller components 23A and 23C, one 23A with sides a-a on top and a different one 23C with sides c-c on the bottom. The multi-sized V-shaped roller component may be used with a base 21B having a V-shaped bottom roller component 22D, such as in FIG. 3 which shows two inverted V-shaped lines 23D and 23B representing the V-shaped roller components of the multi-sized V-shaped roller component of FIGS. 4A and 4B to produce double cone shaped beads 32D and 32B.

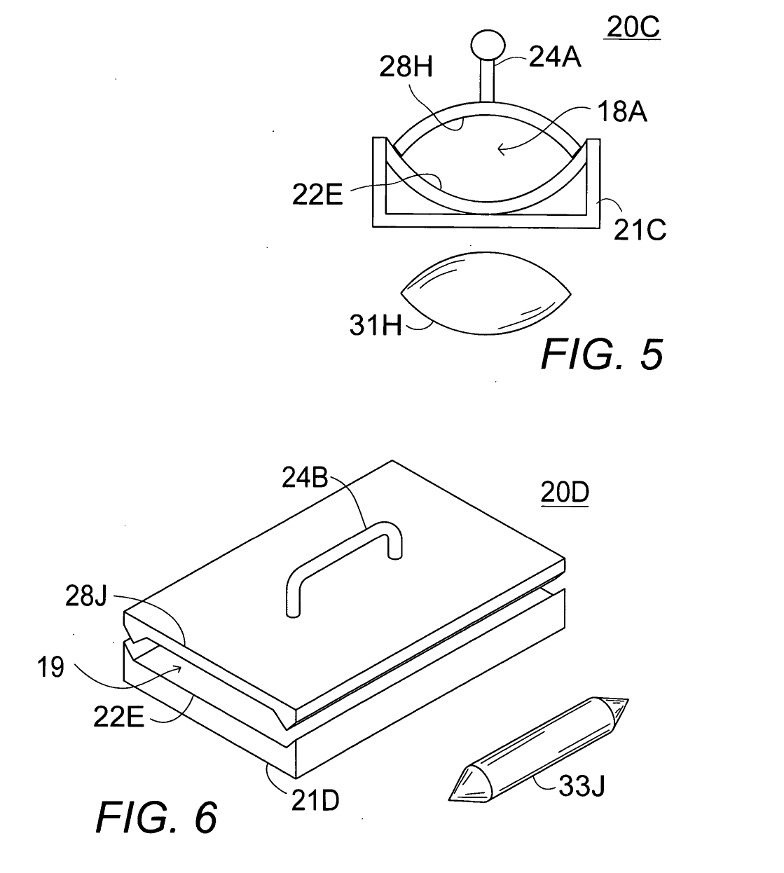

In FIG. 5, a bead roller has a single partial circle arc-shaped roller component 22E in the base 21C and a mating single partial circle arc-shaped roller component 28H with a handle 24A on the top riding in the lower bead roller component to produce an oval football-shaped bead 31H.

In FIG. 6, a bead roller has a base 21D with a single bottom roller component 22E and a mating single top roller component 28 with a handle 24B wherein the two mating roller components have elongated surfaces shaped in cross-section with long central parallel flat surfaces with outwardly angled ends forming a bead roller chamber 19 therebetween which produces a cylindrical bead with cone-shaped ends 33J.

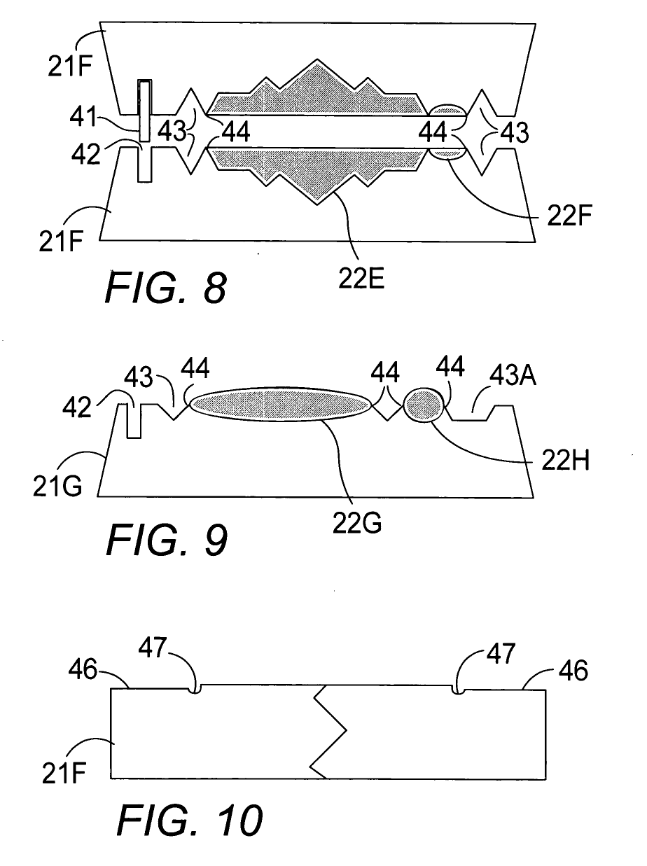

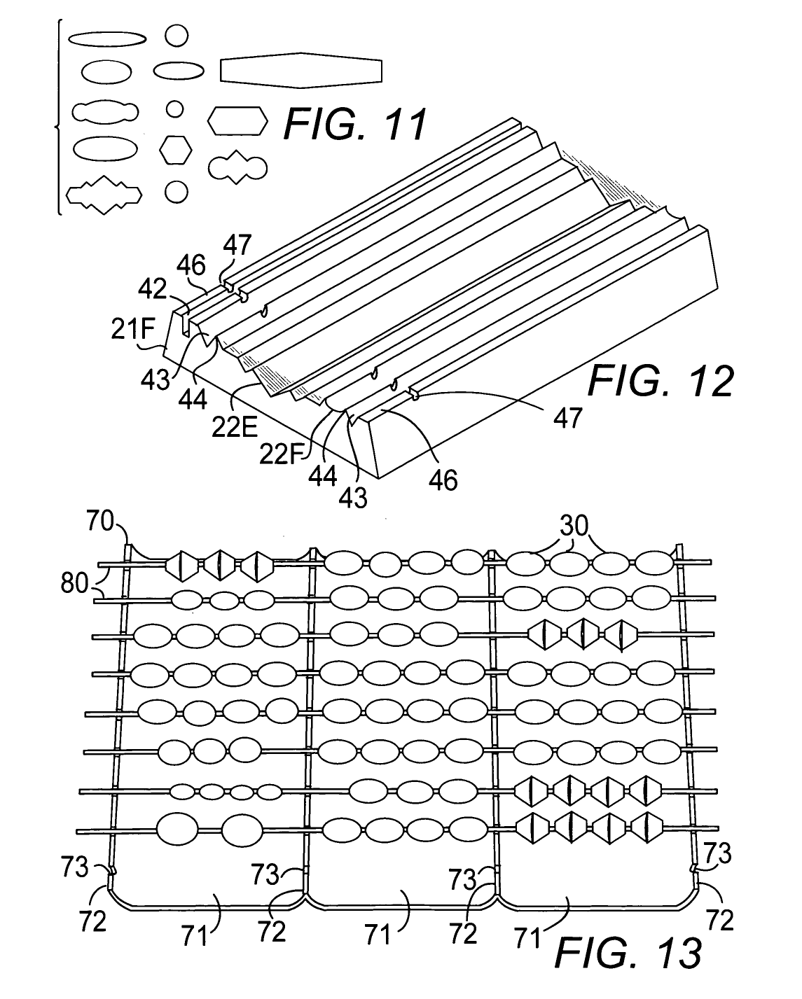

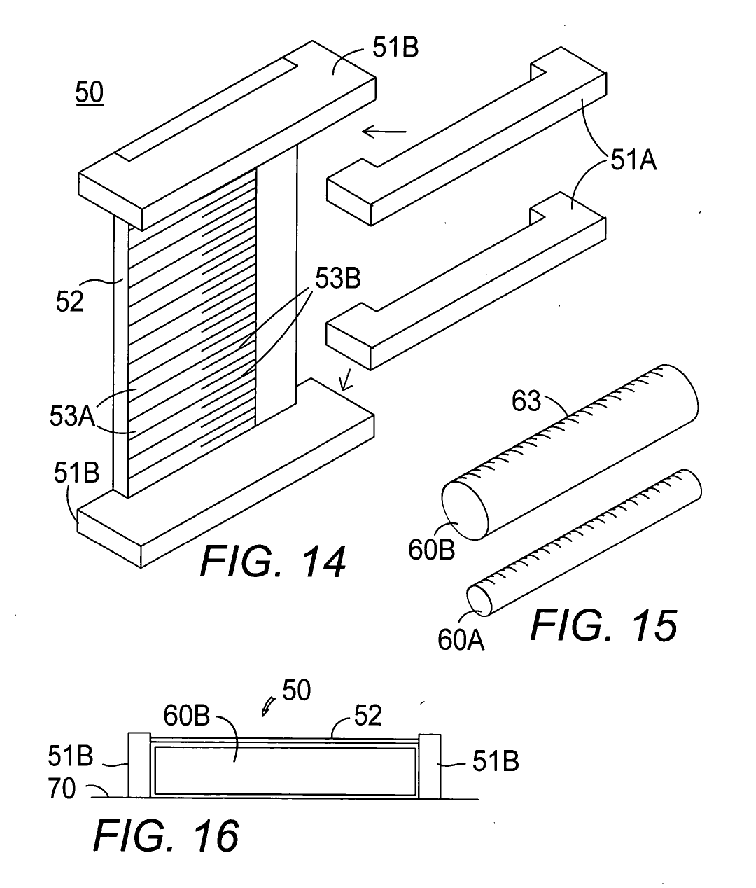

In the preferred embodiment of FIGS. 8-16, a bead roller system for rolling a plurality of different varieties of beads from polymer clay and other similar material, the beads uniformly shaped and sized within each of the varieties, comprises:

a means for measuring 50 a quantity of polymer clay or similar material for use with the bead roller system;

an elongated bead roller tool 21F and 21G comprising at least one pair of roller components fabricated of a material which is impervious to chemical reaction with polymer clay and other similar material, the pair of roller components having a plurality of elongated matched surfaces 22E, 22F, and 22G adapted for coming into mutual contact to form a plurality of different bead roller chambers (shown shaded0 between the matched surfaces, the matched surfaces being transparent, and a means for maintaining the elongated matched surfaces in mutual alignment, each of the bead roller chambers adapted for receiving a measured amount of polymer clay therein, and the at least one pair of roller components adapted for hand operated relative motion in the direction of elongation to roll the clay back and forth between the elongated matched surfaces while a user observes a formation of each bead through the transparent surfaces, to form a bead having a smooth shape with a circular transverse cross-section and a shape and size uniformly matched to other beads rolled therein, the elongated tool adapted for producing a plurality of beads each structured with at least one axis of symmetry to provide a central axis therethrough adapted for receiving a tool to produce an opening therethrough for stringing each of the beads;

the roller components being formed by a mass production process of a material resistant to chemical interaction with polymer clay and other similar material to insure smooth outer surfaces on the beads.

In FIGS. 14-16, the means for measuring a quantity of polymer clay or similar material comprises a measurement embossing adjustable height log roller 50, having a series of two paired sides 51A and 51B adapted to be replaceable on the log roller, each of the paired sides equal in height to a desired log 60A and 60B diameter and each of the paired sides adapted to contact and move along a flat external surface 70, such as a table top, and a cross piece 52 removably connectable to each of the paired sides 51A and 51B at a top edge of each of the paired sides, the cross piece bearing protruding indicia 53A and 53B on a lower surface, the log roller adapted for rolling out a piece of polymer clay or similar material into a log 60A and 60B of an appropriate diameter for intended use in one of the bead roller chambers, the protruding indicia adapted for embossing the indicia 63 into an outer surface of the log 60B along the length of the log, the indicia 63 indicating measured dimensions along the log so that the log is adapted for cutting the exact length of clay needed for an intended bead roller chamber.

In FIGS. 10 and 12, each of the bead roller tool pair of components is formed into a series of longitudinal channels separated by longitudinal ridges and the elongated bead roller tool is provided with a transverse pin slot 47 through a top point of each of the ridges, the pin slots in alignment to admit a pin 80 (shown in FIG. 13) through all of the slots to pierce at least one bead 30 in the bead roller tube through the exact axis of symmetry of the bead in the bead roller tool thereby forming a hole through the bead for stringing the bead and enabling the bead to be removed from the bead roller tool by handling only the pin and not the bead after separating the pair of roller components.

In FIG. 10 a recessed pin rolling ledge 46 on each of the series of ridges from the pin slot 47 to an adjacent end of the bead roller device to allow the bead to be rolled on the pin along the pin rolling ledges to smooth out deformations made by the pin piercing the bead.

In FIGS. 8, 9, and 12, each of the bead roller tool pair of components is formed into a series of longitudinal channels separated by longitudinal ridges and the bead roller tool further comprises at least one clay overflow channel 43 adjacent to and parallel to a bead roller channel 22 of the bead roller chamber to receive excess clay from the bead roller chamber.

In FIGS. 8, 9, and 12, a longitudinal ridge 44 between the bead roller channel 22 and the clay overflow channel 43 comprises a sharp edge to cut of the excess clay cleanly and allow it to fall into the overflow channel.

In FIGS. 8-12, the system may employ a pair of roller components 21F which are identical in structure so that they are adapted to be made from the same mold and thereby have identical surfaces, and the means for maintaining the elongated matched surfaces in mutual alignment comprises the pair of identical roller components each having at least one longitudinal mating guide channel 42 and further comprising a guide bar 41 adapted to be inserted in one of the channels of one of the pair of roller components and adapted to ride in a mating channel in the other of the pair of roller components to insure even alignment of the two components as they are moved back and forth to make a perfectly formed bead.

In FIG. 13, the system further comprises a means for drying the beads after formation, the means comprising a heat resistant bead drying rack 70 having a series of elevated longitudinal spaced drying rack edges 72 forming a series of recessed drying rack troughs 71 between each pair of adjacent drying rack ridges, each of the drying rack ridges having a series of spaced drying rack pin notches 73 aligned with a series of spaced drying rack pin notches in all of the other drying rack ridges all aligned transversely across all of the ridges to receive a series of bead holding pins 80 sufficiently long to rest in the drying rack pin notches across the rack with formed beads 30 skewered on the pins elevated above each of the troughs for drying the beads so that rolled beads can be placed on the drying rack and dried until hard all without touching the beads thereby providing smooth beads with no finger indentations or fingerprints, the drying rack adapted to fit within a toaster type oven.

The roller components are preferably formed from a transparent polycarbonate material.

In practice, a bead roller method for rolling a plurality of different varieties of beads from polymer clay and other similar material, the beads uniformly shaped and sized within each of the varieties, the device comprising:

a first step of measuring a quantity of polymer clay or similar material with a means for measuring clay for use with the bead roller system;

a second step of placing the measured quantity of polymer clay or similar material in an elongated bead roller tool comprising at least one pair of roller components fabricated of a material which is impervious to chemical reaction with polymer clay and other similar material, the pair of roller components having a plurality of elongated matched surfaces adapted for coming into mutual contact to form a plurality of different bead roller chambers between the matched surfaces, the matched surfaces being transparent, and a means for maintaining the elongated matched surfaces in mutual alignment, each of the bead roller chambers adapted for receiving a measured amount of polymer clay therein, and hand operating the at least one pair of roller components to produce relative motion in the direction of elongation to roll the clay back and forth between the elongated matched surfaces while a user observes a formation of each bead through the transparent surfaces, to form a bead having a smooth shape with a circular transverse cross-section and a shape and size uniformly matched to other beads rolled therein, the elongated tool adapted for producing a plurality of beads each structured with at least one axis of symmetry to provide a central axis therethrough adapted for receiving a tool to produce an opening therethrough for stringing each of the beads;

the roller components being formed by a mass production process of a material resistant to chemical interaction with polymer clay and other similar material to insure smooth outer surfaces on the beads.

The first step comprises rolling a log of clay by rolling a quantity of polymer clay other similar material over a flat external surface using a means for measuring a quantity of polymer clay or similar material comprising a measurement embossing adjustable height log roller having a series of two paired sides adapted to be replaceable on the log roller, each of the paired sides equal in height to a desired log diameter and each of the paired sides adapted to contact and move along a flat external surface, and a cross piece removably connectable to each of the paired sides at a top edge of each of the paired sides, the cross piece bearing protruding indicia on a lower surface, the log roller adapted for rolling out a piece of polymer clay or similar material into a log of an appropriate diameter for intended use in one of the bead roller chambers, the protruding indicia adapted for embossing the indicia into an outer surface of the log along the length of the log, the indicia indicating measured dimensions along the log and cutting the exact length of clay needed for an intended bead roller chamber using the measured dimensions along the log.

The second step further comprises the step of forming a hole the exact axis of symmetry of at least one formed bead in the bead roller tool, wherein each of the bead roller tool pair of components is formed into a series of longitudinal channels separated by longitudinal ridges and the elongated bead roller tool is provided with a transverse pin slot through a top point of each of the ridges, the pin slots in alignment to admit a pin through all of the slots to pierce at least one bead in the bead roller tube through the exact axis of symmetry of the bead in the bead roller tool thereby forming a hole through the bead for stringing the bead and separating the pair of roller components and removing the at least one bead from the bead roller tool by handling only the pin and not the bead.

The second step further comprises the step of smoothing out any deformations made by the pin piercing the at least one bead by rolling the pin on a recessed pin rolling ledge on each of the series of ridges from the pin slot to an adjacent end of the bead roller device.

A third step of drying a number of rolled beads using a drying means for drying the beads after formation, the means comprising a heat resistant bead drying rack having a series of elevated longitudinal spaced drying rack edges forming a series of recessed drying rack troughs between each pair of adjacent drying rack ridges, each of the drying rack ridges having a series of spaced drying rack pin notches aligned with a series of spaced drying rack pin notches in all of the other drying rack ridges all aligned transversely across all of the ridges to receive a series of bead holding pins sufficiently long to rest in the drying rack pin notches across the rack with formed beads skewered on the pins elevated above each of the troughs for drying the beads so that rolled beads can be placed on the drying rack and dried until hard all without touching the beads thereby providing smooth beads with no finger indentations or fingerprints, placing the pins with beads in the drying rack notches and placing the drying rack in a heating source such as a toaster type oven.

The second step further comprises guiding the pair of roller components while rolling at least one bead by using a pair of roller components which are identical in structure so that they are adapted to be made from the same mold and thereby have identical surfaces, and the means for maintaining the elongated matched surfaces in mutual alignment comprises the pair of identical roller components each having at least one longitudinal mating guide channel and further comprising a guide bar adapted to be inserted in one of the channels of one of the pair of roller components and adapted to ride in a mating channel in the other of the pair of roller components to insure even alignment of the two components as they are moved back and forth to make a perfectly formed bead.

In FIGS. 4A and 4B, alternately the second step comprises rolling at least one bead using a bead roller tool comprising an elongated element having two multisided pieces, of mirror image in cross-section, interlocked by a connecting means enabling the first piece to be attachable on the left side of the second piece and alternately on the right side, each piece comprising elongated angled surfaces of four different widths with two surfaces on the top and two surfaces on the bottom so that when connected together the two pieces form a multiple sized V-shaped roller component, with V-shaped roller components of four different sizes adapted for being used with another V-shaped roller for rolling four differently sized beads.

The second step may comprise using at least two differently colored clays together in the measured quantity of polymer clay and rolling the clay only in one direction repeatedly by repositioning the clay at the same edge of the bead roller tool after each roll and repeating the same roll direction to produce a swirl pattern in a rolled bead.

It is understood that the preceding description is given merely by way of illustration and not in limitation of the invention and that various modifications may be made thereto without departing from the spirit of the invention as claimed.

What is claimed is:

1. A bead roller system for rolling a plurality of different varieties of beads from polymer clay and other similar material, the beads uniformly shaped and sized within each of the varieties, the device comprising:
a means for measuring a quantity of polymer clay or similar material for use with the bead roller system;
an elongated bead roller tool comprising at least one pair of roller components fabricated of a material which is impervious to chemical reaction with polymer clay and other similar material, the pair of roller components having a plurality of elongated matched surfaces adapted for coming into mutual contact to form a plurality of different bead roller chambers between the matched surfaces, the matched surfaces being transparent, and a means for maintaining the elongated matched surfaces in mutual alignment, each of the bead roller chambers adapted for receiving a measured amount of polymer clay therein, and the at least one pair of roller components adapted for hand operated relative motion in the direction of elongation to roll the clay back and forth between the elongated matched surfaces while a user observes a formation of each bead through the transparent surfaces, to form a bead having a smooth shape with a circular transverse cross-section and a shape and size uniformly matched to other beads rolled therein, the elongated tool adapted for producing a plurality of beads each structured with at least one axis of symmetry to provide a central axis therethrough adapted for receiving a tool to produce an opening therethrough for stringing each of the beads;
the roller components being formed by a mass production process of a material resistant to chemical interaction with polymer clay and other similar material to insure smooth outer surfaces on the beads.

2. The system of claim 1 wherein the means for measuring a quantity of polymer clay or similar material comprises a measurement embossing adjustable height log roller, having a series of two paired sides adapted to be replaceable on the log roller, each of the paired sides equal in height to a desired log diameter and each of the paired sides adapted to contact and move along a flat external surface, and a cross piece removably connectable to each of the paired sides at a top edge of each of the paired sides, the cross piece bearing protruding indicia on a lower surface, the log roller adapted for rolling out a piece of polymer clay or similar material into a log of an appropriate diameter for intended use in one of the bead roller chambers, the protruding indicia adapted for embossing the indicia into an outer surface of the log along the length of the log, the indicia indicating measured dimensions along the log so that the log is adapted for cutting the exact length of clay needed for an intended bead roller chamber.

3. The system of claim 1 wherein each of the bead roller tool pair of components is formed into a series of longitudinal channels separated by longitudinal ridges and the elongated bead roller tool is provided with a transverse pin slot through a top point of each of the ridges, the pin slots in alignment to admit a pin through all of the slots to pierce at least one bead in the bead roller tube through the exact axis of symmetry of the bead in the bead roller tool thereby forming a hole through the bead for stringing the bead and enabling the bead to be removed from the bead roller tool by handling only the pin and not the bead after separating the pair of roller components.

4. The system of claim 3 further comprising a recessed pin rolling ledge on each of the series of ridges from the pin slot to an adjacent end of the bead roller device to allow the bead to be rolled on the pin along the pin rolling ledges to smooth out deformations made by the pin piercing the bead.

5. The system of claim 1 wherein each of the bead roller tool pair of components is formed into a series of longitudinal channels separated by longitudinal ridges and the bead roller tool further comprises at least one clay overflow channel adjacent to and parallel to a bead roller channel of the bead roller chamber to receive excess clay from the bead roller chamber.

6. The system of claim 5 wherein a longitudinal ridge between the bead roller channel and the clay overflow channel comprises a sharp edge to cut of the excess clay cleanly and allow it to fall into the overflow channel.

7. The system of claim 1 wherein the pair of roller components are identical in structure so that they are adapted to be made from the same mold and thereby have identical surfaces, and the means for maintaining the elongated matched surfaces in mutual alignment comprises the pair of identical roller components each having at least one longitudinal mating guide channel and further comprising a guide bar adapted to be inserted in one of the channels of one of the pair of roller components and adapted to ride in a mating channel in the other of the pair of roller components to insure even alignment of the two components as they are moved back and forth to make a perfectly formed bead.

8. The system of claim 1 further comprising a means for drying the beads after formation, the means comprising a heat resistant bead drying rack having a series of elevated longitudinal spaced drying rack edges forming a series of recessed drying rack troughs between each pair of adjacent drying rack ridges, each of the drying rack ridges having a series of spaced drying rack pin notches aligned with a series of spaced drying rack pin notches in all of the other drying rack ridges all aligned transversely across all of the ridges to receive a series of bead holding pins sufficiently long to rest in the drying rack pin notches across the rack with formed beads skewered on the pins elevated above each of the troughs for drying the beads so that rolled beads can be placed on the drying rack and dried until hard all without touching the beads thereby providing smooth beads with no finger indentations or fingerprints, the drying rack adapted to fit within a toaster type oven.

9. The system of claim 1 wherein the roller components are formed from a polycarbonate material.

10. The system of claim 1 further comprising an elongated element having two multisided pieces, of mirror image in cross-section, interlocked by a connecting means enabling the first piece to be attachable on the left side of the second piece and alternately on the right side, each piece comprising elongated angled surfaces of four different widths with two surfaces on the top and two surfaces on the bottom so that when connected together the two pieces form a multiple sized V-shaped roller component, with V-shaped roller components of four different sizes adapted for being used with another V-shaped roller for rolling four differently sized beads.

11. A bead roller method for rolling a plurality of different varieties of beads from polymer clay and other similar material, the beads uniformly shaped and sized within each of the varieties, the device comprising:
a first step of measuring a quantity of polymer clay or similar material with a means for measuring clay for use with the bead roller system;
a second step of placing the measured quantity of polymer clay or similar material in an elongated bead roller tool comprising at least one pair of roller components fabricated of a material which is impervious to chemical reaction with polymer clay and other similar material, the pair of roller components having a plurality of elongated matched surfaces adapted for coming into mutual contact to form a plurality of different bead roller chambers between the matched surfaces, the matched surfaces being transparent, and a means for maintaining the elongated matched surfaces in mutual alignment, each of the bead roller chambers adapted for receiving a measured amount of polymer clay therein, and hand operating the at least one pair of roller components to produce relative motion in the direction of elongation to roll the clay back and forth between the elongated matched surfaces while a user observes a formation of each bead through the transparent surfaces, to form a bead having a smooth shape with a circular transverse cross-section and a shape and size uniformly matched to other beads rolled therein, the elongated tool adapted for producing a plurality of beads each structured with at least one axis of symmetry to provide a central axis therethrough adapted for receiving a tool to produce an opening therethrough for stringing each of the beads;
the roller components being formed by a mass production process of a material resistant to chemical interaction with polymer clay and other similar material to insure smooth outer surfaces on the beads.

12. The method of claim 11 wherein the first step comprises rolling a log of clay by rolling a quantity of polymer clay other similar material over a flat external surface using a means for measuring a quantity of polymer clay or similar material comprising a measurement embossing adjustable height log roller having a series of two paired sides adapted to be replaceable on the log roller, each of the paired sides equal in height to a desired log diameter and each of the paired sides adapted to contact and move along a flat external surface, and a cross piece removably connectable to each of the paired sides at a top edge of each of the paired sides, the cross piece bearing protruding indicia on a lower surface, the log roller adapted for rolling out a piece of polymer clay or similar material into a log of an appropriate diameter for intended use in one of the bead roller chambers, the protruding indicia adapted for embossing the indicia into an outer surface of the log along the length of the log, the indicia indicating measured dimensions along the log and cutting the exact length of clay needed for an intended bead roller chamber using the measured dimensions along the log.

13. The method of claim 11 wherein the second step further comprises the step of forming a hole the exact axis of symmetry of at least one formed bead in the bead roller tool, wherein each of the bead roller tool pair of components is formed into a series of longitudinal channels separated by longitudinal ridges and the elongated bead roller tool is provided with a transverse pin slot through a top point of each of the ridges, the pin slots in alignment to admit a pin through all of the slots to pierce at least one bead in the bead roller tube through the exact axis of symmetry of the bead in the bead roller tool thereby forming a hole through the bead for stringing the bead and separating the pair of roller components and removing the at least one bead from the bead roller tool by handling only the pin and not the bead.

14. The method of claim 13 wherein the second step further comprises the step of smoothing out any deformations made by the pin piercing the at least one bead by rolling the pin on a recessed pin rolling ledge on each of the series of ridges from the pin slot to an adjacent end of the bead roller device.

15. The method of claim 13 further comprising a third step of drying a number of rolled beads using a drying means for drying the beads after formation, the means comprising a heat resistant bead drying rack having a series of elevated longitudinal spaced drying rack edges forming a series of recessed drying rack troughs between each pair of adjacent drying rack ridges, each of the drying rack ridges having a series of spaced drying rack pin notches aligned with a series of spaced drying rack pin notches in all of the other drying rack ridges all aligned transversely across all of the ridges to receive a series of bead holding pins sufficiently long to rest in the drying rack pin notches across the rack with formed beads skewered on the pins elevated above each of the troughs for drying the beads so that rolled beads can be placed on the drying rack and dried until hard all without touching the beads thereby providing smooth beads with no finger indentations or fingerprints, placing the pins with beads in the drying rack notches and placing the drying rack in a heating source such as a toaster type oven.

16. The method of claim 11 wherein the second step further comprises guiding the pair of roller components while rolling at least one bead by using a pair of roller components which are identical in structure so that they are adapted to be made from the same mold and thereby have identical surfaces, and the means for maintaining the elongated matched surfaces in mutual alignment comprises the pair of identical roller components each having at least one longitudinal mating guide channel and further comprising a guide bar adapted to be inserted in one of the channels of one of the pair of roller components and adapted to ride in a mating channel in the other of the pair of roller components to insure even alignment of the two components as they are moved back and forth to make a perfectly formed bead.

17. The method of claim 11 wherein the second step comprises rolling at least one bead using a bead roller tool comprising an elongated element having two multisided pieces, of mirror image in cross-section, interlocked by a connecting means enabling the first piece to be attachable on the left side of the second piece and alternately on the right side, each piece comprising elongated angled surfaces of four different widths with two surfaces on the top and two surfaces on the bottom so that when connected together the two pieces form a multiple sized V-shaped roller component, with V-shaped roller components of four different sizes adapted for being used with another V-shaped roller for rolling four differently sized beads.

18. The method of claim 11 wherein the second step comprises using at least two differently colored clays together in the measured quantity of polymer clay and rolling the clay only in one direction repeatedly by repositioning the clay at the same edge of the bead roller tool after each roll and repeating the same roll direction to produce a swirl pattern in a rolled bead.
